(19) United States
(12) Patent Application Publication
(10) Pub. No.: US 2007/0231617 A1
(43) Pub. Date: Oct. 4, 2007

(54) Rechargeable and pluggable electric power storage device

(76) Inventor: Yaz-Tzung Wu, Taipei (TW)

Correspondence Address: RABIN & Berdo, PC, 1101 14TH STREET, NW, SUITE 500, WASHINGTON, DC, 20005, US

(21) Appl. No.: 11/391,356

(22) Filed: Mar. 29, 2006

(51) Int. Cl. H01M 10/00

(52) U.S. Cl. 429/7

(57) ABSTRACT

A rechargeable and pluggable electric power storage device used as a backup battery for an electronic device is provided, which is used for both charging and plugging in, i.e., the electric power is stored through charging; after having been charged, the rechargeable and pluggable electric power storage device serves as an independent backup battery and is connected and used to supply power in parallel and in series. The rechargeable and pluggable electric power storage device mainly consists of a secondary battery for storing electric power and two electrical wires, and through the adjusting in the circuit design, it can be connected and used to supply power in parallel or in series.

### BACKGROUND OF THE INVENTION

1. Field of Invention

The present invention relates to a charging device for supplying electric power to an electronic device, and more particularly, to a chargeable and pluggable electric power storage device, which can be used for both charging and plugging in, and for supplying power in parallel or in series according to requirements.

2. Related Art

Most common portable electronic devices are provided with more than one battery to provide electric power. Referring to FIG. 1, it shows a conventional notebook computer 101 with a rechargeable battery 102 for supplying electric power. As shown in the figure, the rechargeable battery 102 is disposed in the rear side of the notebook computer 101 and contacts the electrodes within the notebook computer 101 through connecting fingers 1021. That is, the rechargeable battery 102 and the notebook computer 101 are assembled together. At present, the average run time of Lithium batteries available on the market is about four and a half hours. However, if a lot of motion pictures are played, the time for which the batteries last will be further reduced. Generally, a user will take one more battery along or simply take an alternating current (AC) adopter for emergency use in case of low-battery. The current conventional battery must be charged first through a charger and then be taken out. However, due to the weight of the charger itself, it is inconvenient to be carried out. Furthermore, the AC adopter is also a burden to carry. What's more, there must be a power outlet for plugging in to charge the notebook computer, which is truly inconvenient for the user.

### SUMMARY OF THE INVENTION

In view of the aforementioned problem, an object of the present invention is to provide a rechargeable and pluggable electric power storage device, which is more practical and more suitable for being carried along.

The rechargeable and pluggable electric power storage device provided by the present invention mainly includes a secondary battery capable of storing electric power and two electrical wires electrically connected to the secondary battery, such that the electric power storage device can be plugged into an electronic device according to requirements, thereby supplying power to the electronic device. Further, through adjustment of the electrical connection method, the rechargeable and pluggable electric power storage device provided by the present invention can be adjusted to supply power in parallel or in series according to requirements.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

It is to be understood that, both the above description of the content of the present invention and the following detailed description intend to demonstrate and illustrate the principle of the invention, and to provide further explanation of the invention as claimed.

### BRIEF DESCRIPTION OF THE DRAWINGS

FIG. 1 is a conventional notebook computer;

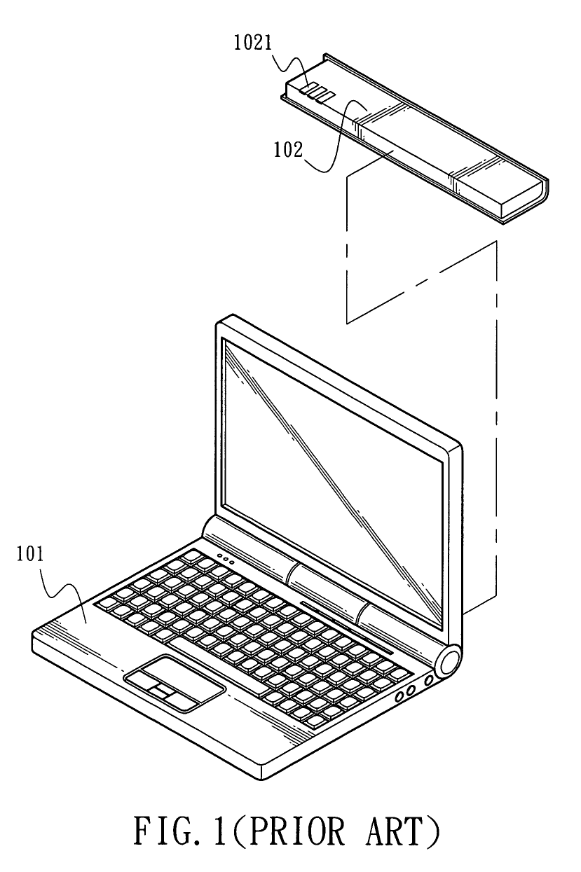

FIG. 2 is a schematic view of the assembling process of the present invention;

FIG. 3 is a view after the assembling of present invention has been completed;

FIG. 4 is a schematic view of a circuit layout (in parallel) of the present invention;

FIG. 5 is a schematic view of a circuit layout (in series) of the present invention; and

FIG. 6 shows an embodiment of the present invention.

### DETAILED DESCRIPTION OF THE INVENTION

In order to make the objects, structures, features, and functions of the present invention more comprehensible, a preferred embodiment is described in detail below with reference to the accompanying figures.

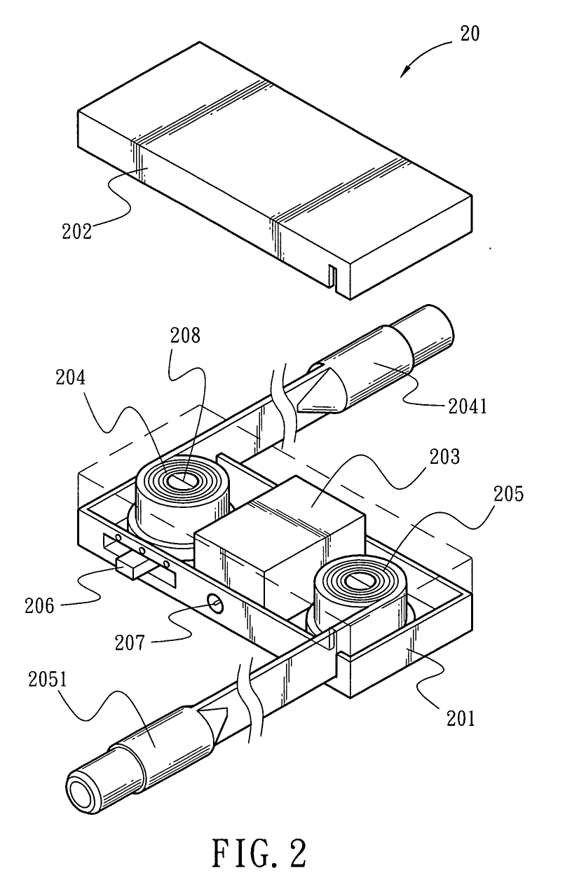

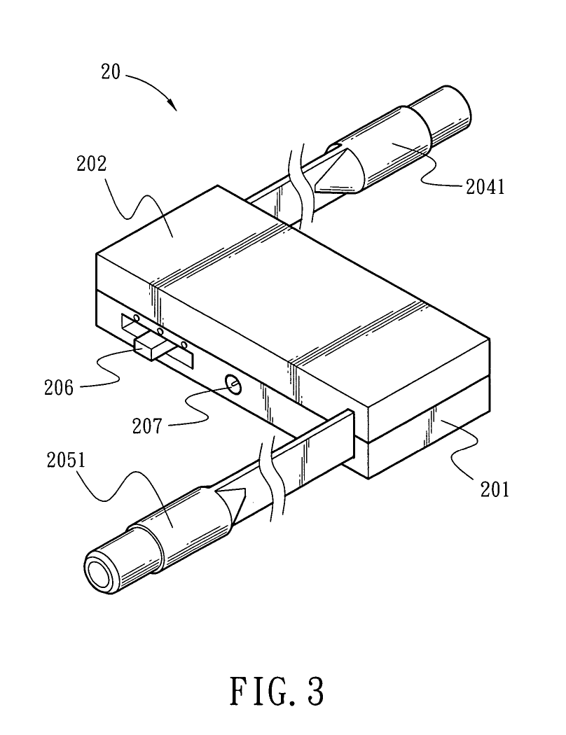

Referring to FIG. 2, it is a schematic view of the assembling process the rechargeable and pluggable electric power storage device provided by the present invention. As shown in the figure, the electric power storage device 20 provided by the present invention mainly includes a secondary battery 203, a first electrical wire 204, a second electrical wire 205, a power supply adjuster 206, and a charging jack 207, wherein the secondary battery 203 is electrically connected to the first electrical wire 204 and the second electrical wire 205 respectively. Further, the first electrical wire 204 is connected with a first electrical connector 2041, such as a terminal plug, and the second electrical wire 205 is connected with a second electrical connector 2051, such as a terminal plug. Further, the power supply adjuster 206 is mainly used to modulate the power-supplying manner, i.e., in parallel or in series, to meet the requirements of the user. Additionally, the charging jack 207 is used for an AC adopter (not shown) to plug in, which is used for charging. Further, the aforementioned components may be assembled between a lower housing body 201 and an upper housing body 202. After the assembling process has been completed, it is shown in FIG. 3. Further, again referring to FIG. 2, a revolving reset spring 208 is further disposed to facilitate the furling and collecting of the first electrical wire and the second electrical wire, such that the electrical wires may be automatically furled back after being pulled out.

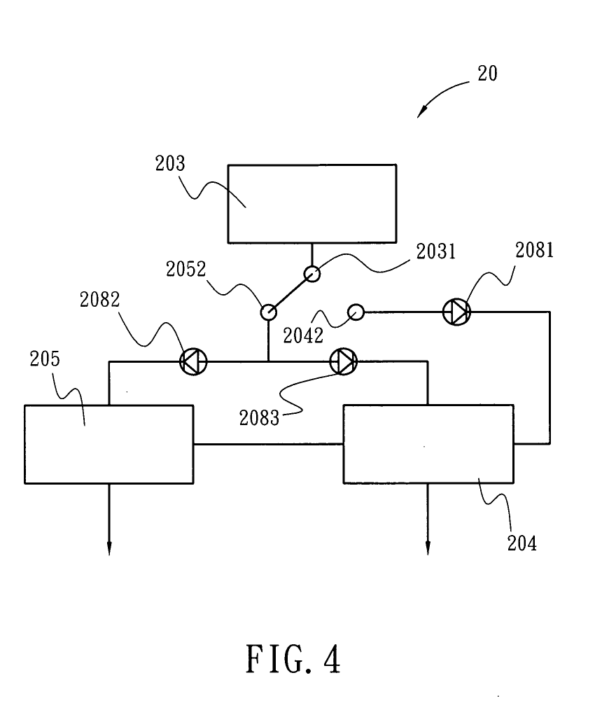

Referring to FIG. 4, it is a schematic view of a circuit layout of the rechargeable and pluggable electric power storage device 20 of the present invention. As shown in the figure, as for the rechargeable and pluggable electric power storage device 20 of the present invention, the secondary battery 203 has an electrical contact 2031. The second electrical wire 205 and the first electrical wire 204 are electrically connected in parallel, wherein a second electrical contact 2052 is provided on one end of the parallel circuit, and a backward diode 2082 is connected between the second electrical contact 2052 and the second electrical wire 205. Further, another backward diode 2083 is connected between the first electrical wire 204 and the second electrical contact 2052. Besides, the first electrical wire 204 and a first electrical contact 2042 are electrically connected with each other, with a backward diode 2081 connected there-between. Referring to FIG. 4, the electric power is supplied in parallel, i.e., the first electrical wire 204 and the second electrical wire 205 may be used to supply power simultaneously, as shown by the arrows in the figure. Further, each of the backward diodes 2081, 2082, and 2083 is used to prevent the current from flowing back.

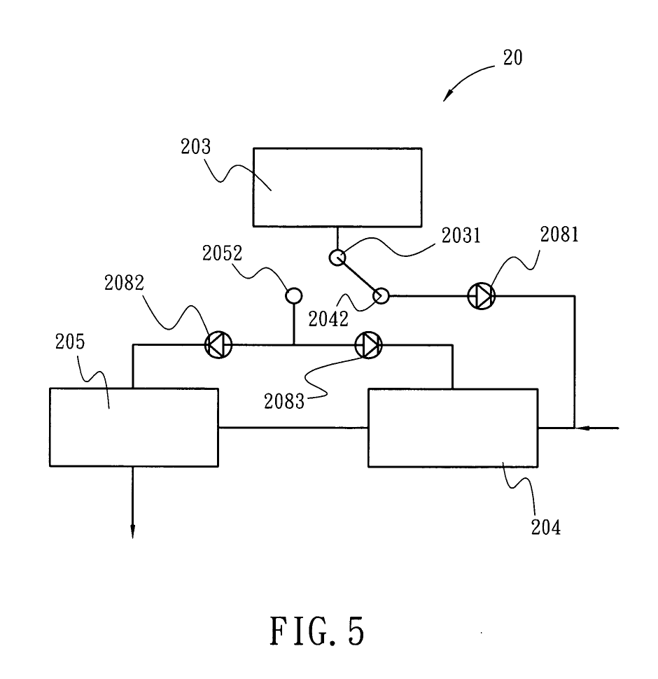

Referring to FIG. 5, it shows the power being supplied in series. As shown in the figure, the electrical contact 2031 is electrically connected to the first electrical contact 2042, such that the current can flow to the second electrical wire 205 via the first electrical wire 204 and then be output. As can be known from the illustrations of FIGS. 4 and 5, the rechargeable and pluggable electric power storage device 20 provided by the present invention can be used to supply power both in parallel and in series according to the requirements of the user, wherein the power-supplying manner is changed by switching one electrical contact.

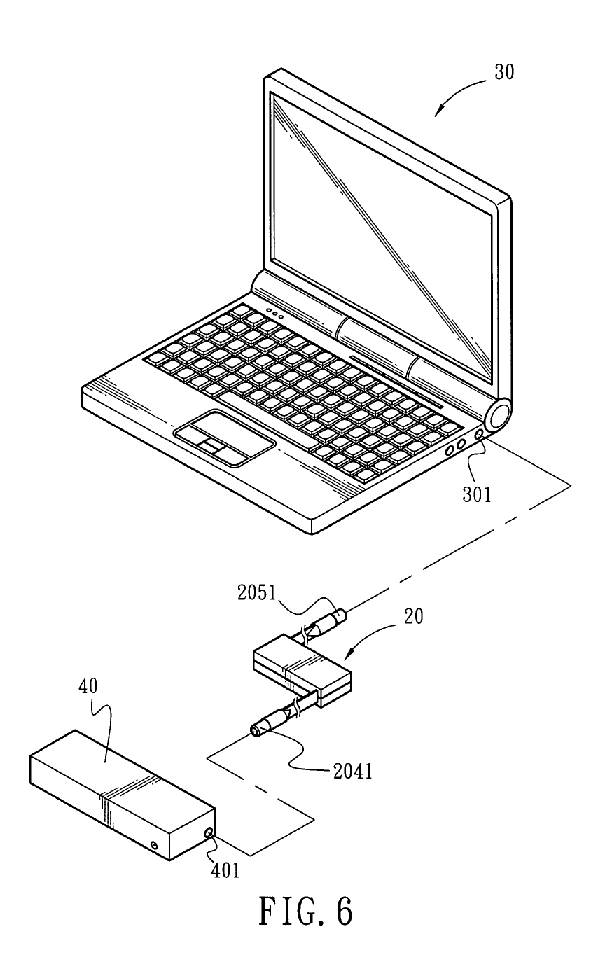

Referring to FIG. 6, it shows a preferred embodiment of the present invention. As shown in the figure, a notebook computer 30 includes a power supply jack 301, for the second electrical connector 2051 of the rechargeable and pluggable electric power storage device 20 of the present invention to be plugged in, and the first electrical connector 2041 may further be electrically connected to a jack 401 of a secondary battery 40 according to requirements.

In view of the above, the rechargeable and pluggable electric power storage device provided by the present invention is capable of storing electric power by itself, and may supply power to mobile electronic devices independently after being charged; and it also can be further used as an electrically connected transmission line, i.e., an extension line, between two electronic devices, thereby greatly enhancing its practicability. Therefore, once the rechargeable and pluggable electric power storage device provided by the present invention is implemented, the object of being more practical and more suitable for carrying along may really be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rechargeable and pluggable electric power storage device used as a power supply for an electronic device, comprising:
a secondary battery, for storing electric power after being charged, wherein the secondary battery has an electrical contact;
a first electrical wire and a second electrical wire, with a parallel circuit and a series circuit formed there-between;
a first electrical contact formed at the terminal of the series circuit, wherein a backward diode is disposed between the first electrical contact and the first electrical wire;
a second electrical contact formed at the parallel circuit, wherein one backward diode is respectively disposed between the second electrical contact and the first electrical wire, as well as the second electrical wire; and
an electrical adjuster, for modulating the electrical connection between the electrical contact and the first electrical contact, or between the electrical contact and the second electrical contact.

2. The rechargeable and pluggable electric power storage device as claimed in claim 1, wherein each of the above components is assembled between an upper housing body and a lower housing body.

3. The rechargeable and pluggable electric power storage device as claimed in claim 1, wherein the secondary battery has a charging jack for an alternating current adopter to plug in.

4. The rechargeable and pluggable electric power storage device as claimed in claim 1, wherein the first electrical wire is connected with an electrical connector, which is a terminal plug.

5. The rechargeable and pluggable electric power storage device as claimed in claim 1, wherein the second electrical wire is connected with an electrical connector, which is a terminal plug.

6. The rechargeable and pluggable electric power storage device as claimed in claim 1, wherein the first electrical wire is provided with a reset spring.

7. The rechargeable and pluggable electric power storage device as claimed in claim 1, wherein the second electrical wire is provided with a reset spring.

8. The rechargeable and pluggable electric power storage device as claimed in claim 1, wherein the electronic device is a notebook computer.
